(19) United States
(12) Patent Application Publication
(10) Pub. No.: US 2012/0147711 A1
(43) Pub. Date: Jun. 14, 2012

(54) TIME INDICATION DEVICE

(75) Inventor: JIN-SHI LAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/040,249

(22) Filed: Mar. 3, 2011

(30) Foreign Application Priority Data
Dec. 10, 2010 (CN) 201010582834.X

(51) Int. Cl. G04B 19/04; G04C 19/00

(52) U.S. Cl. 368/79; 368/80

(57) ABSTRACT

A time indication device includes a time display body, a controller, an hour hand module, a minute hand module, and a second hand module. The hour hand module includes an hour hand ring placed around the time display body. An hour hand driving unit connected to the controller, and controlled by the controller to drive the hour hand ring to rotate around the time display body. An hour hand projecting unit, fixed to the hour hand ring, for projecting an hour hand on the time display body. Thus, when the hour hand ring is driven by the hour hand driving unit to rotate around the time display body, it is shown that the hour hand moves on the time display body. The minute hand module and the second hand module have nearly the same structure as the hour hand module.

### BACKGROUND

1. Technical Field

The present disclosure relates to a time indication device.

2. Description of Related Art

An hour hand, a minute hand, and a second hand of a time indication device are usually separate from each other and controlled by a controller to rotated around an axis to indicate time. Although, conventional time indication devices meet the requirement of the user, there is still a need for providing a new time indication device.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a time indication device in accordance with an exemplary embodiment.

FIG. 2 is a view similar to FIG. 1, but viewed from a different perspective.

FIG. 3 is an exploded view of the time indication device of FIG. 1.

### DETAILED DESCRIPTION

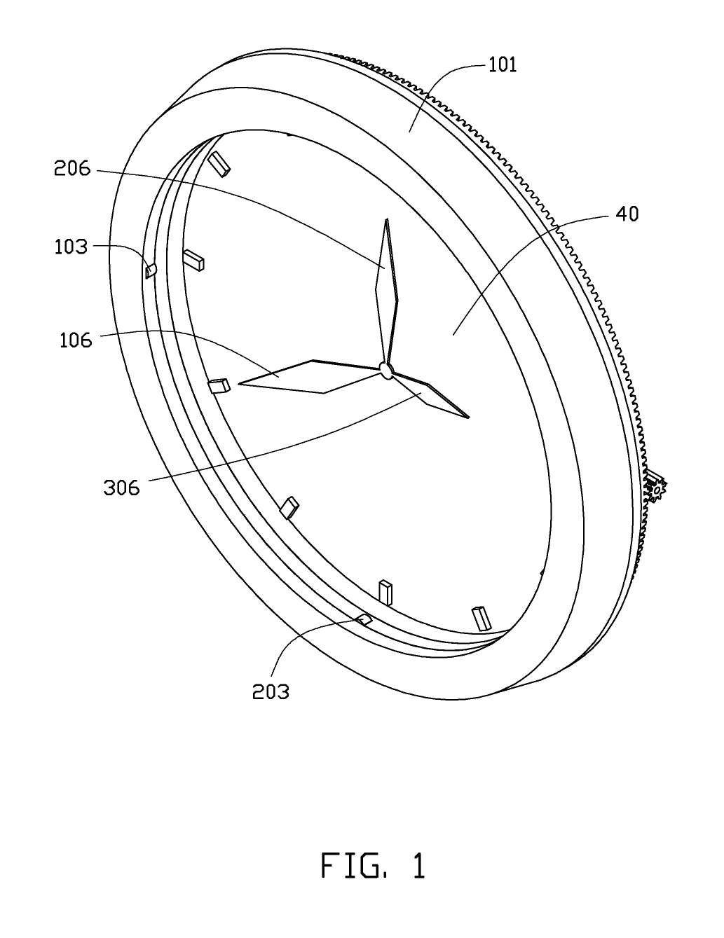

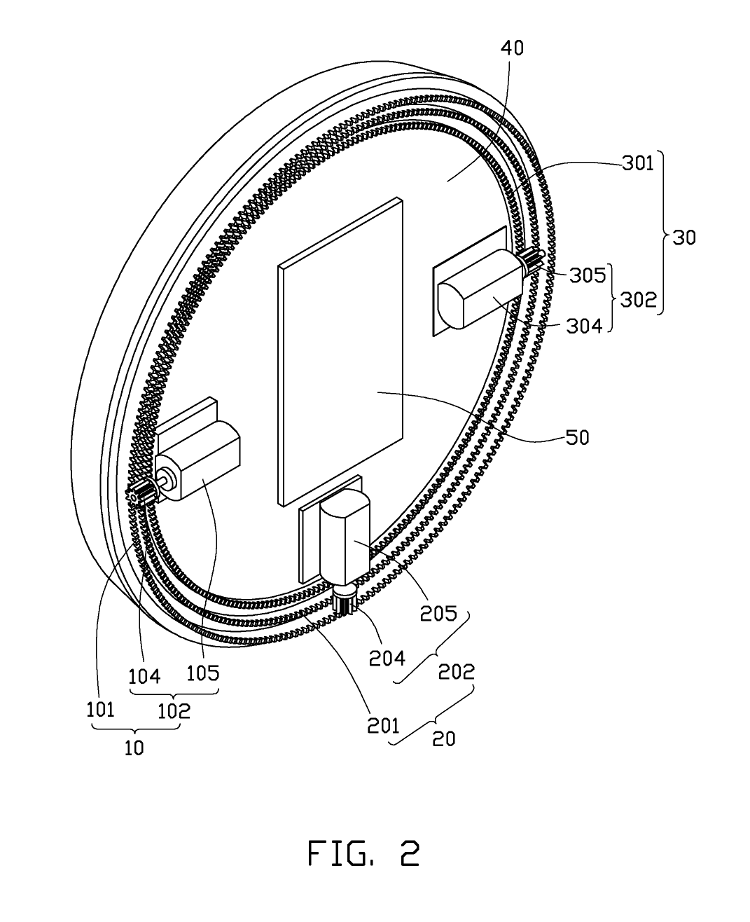

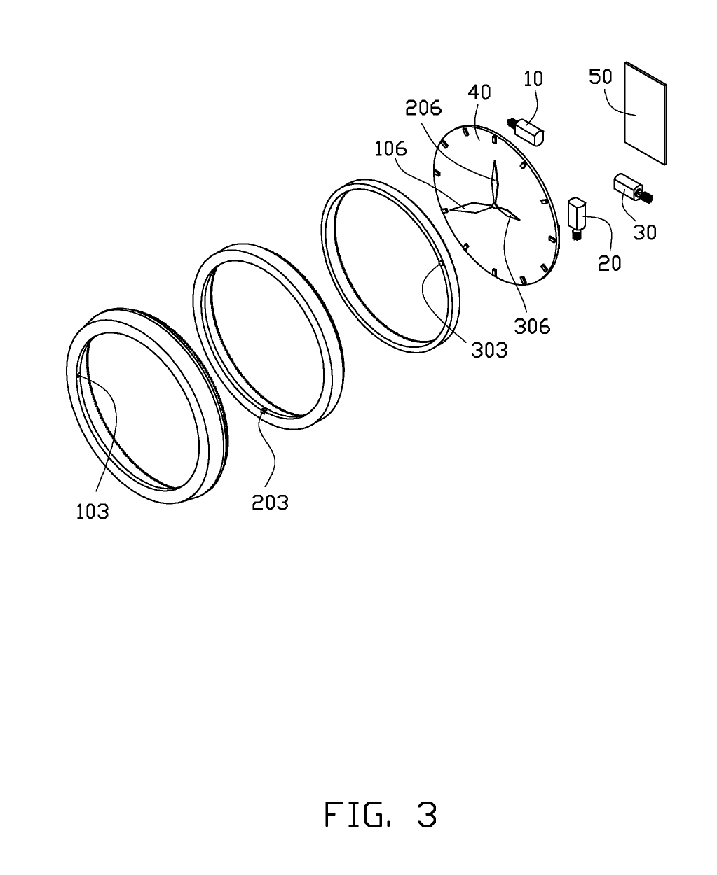

Referring to FIGS. 1-3, a time indication device 1 includes a time display body 40, an hour hand module 10, a minute hand module 20, a second hand module 30, and a controller 50. The controller 50 controls the hour hand module 10, the minute hand module 20, and the second hand module 30 collectively to display time on the time display body 40. The time display body 40 has time calibrations.

The hour hand module 10 includes an hour hand ring 101, an hour hand driving unit 102, and an hour hand projecting unit 103. The hour hand driving unit 102 is connected to the controller 50. The hour hand ring 101 is placed around the time display body 40. The controller 50 controls the hour hand driving unit 102 to drive the hour hand ring 101 to rotate around the time display body 40. The hour hand projecting unit 103, fixed to the hour hand ring 101, is for projecting a virtual hour hand 106 on the time display body 40. The hour hand driving unit 102 includes an hour hand driving wheel 104 and an hour hand driver 105. The time indication device 1 further defines a number of gears on the edge of the hour hand ring 101 and another number of gears on one end of the hour hand driving wheel 104, which engage with the gears of the hour hand ring 101. The other end of the hour hand driving wheel 104 is connected to the hour hand driver 105. The hour hand driver 105 is connected to the controller 50. The controller 50 controls the hour hand driver 105 to run to drive the hour hand driving wheel 104 to rotate. The rotation of the hour hand driving wheel 104 drives the hour hand ring 101 to rotate, thus it is shown that the hour hand 106 moves on the time display body 40.

The minute hand module 20 includes a minute hand ring 201, a minute hand driving unit 202, and a minute hand projecting unit 203. The minute hand driving unit 202 is connected to the controller 50. The minute hand ring 201 is placed inside of the hour hand ring 101. The controller 50 controls the minute hand driving unit 202 to drive the minute hand ring 201 to rotate around the time display body 40. The minute hand projecting unit 203, fixed to the minute hand ring 201, is for projecting a virtual minute hand 206 on the time display body 40. The minute hand driving unit 202 includes a minute hand driving wheel 204 and a minute hand driver 205. The time indication device 1 further defines a number of gears on the edge of the minute hand ring 101 and another number of gears on one end of the minute hand driving wheel 104, which engage with the gears of the minute hand ring 101. The other end of the minute hand driving wheel 204 is connected to the minute hand driver 205. The minute hand driver 205 is connected to the controller 50. The controller 50 controls the minute hand driver 205 to run to drive the minute hand driving wheel 204 to rotate. The rotation of the minute hand driving wheel 204 drives the minute hand ring 201 to rotate, thus it is shown that the minute hand 206 moves on the time display body 40.

The second hand module 30 includes a second hand ring 301, a second hand driving unit 302, and a second hand projecting unit 303. The second hand driving unit 302 is connected to the controller 50. The second hand ring 301 is placed inside of the minute hand ring 201. The controller 50 controls the second hand driving unit 302 to drive the second hand ring 301 to rotate around the time display body 40. The second hand projecting unit 303, fixed to the second hand ring 301, is for projecting a virtual second hand 306 on the time display body 40. The time indication device 1 further defines a number of gears on the edge of the second hand ring 201 and another number of gears on one end of the second hand driving wheel 204, which engage with the gears of the second hand ring 201. The other end of the second hand driving wheel 304 is connected to the second hand driver 305. The second hand driver 305 is connected to the controller 50. The controller 50 controls the second hand driver 305 to run to drive the second hand driving wheel 304 to rotate. The rotation of the second hand driving wheel 304 drives the second hand ring 301 to rotate, thus it is shown that the second hand 306 moves on the time display body 40.

In this embodiment, in order for the hand rings 101, 201 and 301 to rotate without the projecting units 103, 203 and 303 interfering with one another in effectively projecting the hour hand 106, the minute hand 206 and the second hand 306, the axial heights of the hour hand ring 101, the minute hand ring 201, and the second hand ring 301, along the respective axial directions of the rings 101, 201 and 301 (see FIG. 1), are arranged in descending order from outside to inside.

The relative positions of the hour hand ring 101, the minute hand ring 201, and the second hand ring 301 are not limited by the above description. In other embodiments, the hour hand ring 101 can be placed inside of the minute hand ring 201, and the second hand ring 301 can be placed outside of the minute hand ring 201.

In this embodiment, the hour hand projecting unit 103, the minute hand projecting unit 203, and the second hand projecting unit 303 are LEDs.

In this embodiment, the controller 50 controls the hour hand driver 105, minute hand driver 205, and second hand driver 305 rotate in a clockwise direction or a counterclockwise direction, and further drives the hour hand ring 101, the minute hand ring 201, and the second hand ring 301 to rotate in the clockwise direction or the counterclockwise direction, accordingly. If the hour hand ring 101, the minute hand ring 201, and the second hand ring 301 are rotated in clockwise direction, the time calibrations on the time display body 40 are set in clockwise direction. If the hour hand ring 101, the minute hand ring 201, and the second hand ring 301 are rotated in counterclockwise direction, the time calibrations on the time display body 40 are set in counterclockwise direction.

In this embodiment, the hour hand driver 105, the minute hand driver 205, and the second hand driver 305 are motors.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A time indication device comprising
a time display body;
a controller;
an hour hand module comprising:
an hour hand ring being placed around the time display body;
an hour hand driving unit, connected to the controller, being controlled by the controller to drive the hour hand ring to rotate around the time display body; and
an hour hand projecting unit, fixed to the hour hand ring, for projecting an hour hand on the time display body; and
a minute hand module comprising:
a minute hand ring being placed around the time display body;
a minute hand driving unit, connected to the controller, being controlled by the controller to drive the minute hand ring to rotate around the time display body; and
a minute hand projecting unit, fixed to the minute hand ring, for projecting a minute hand on the time display body.

2. The time indication device as described in claim 1, wherein the hour hand driving unit comprises an hour hand driving wheel and an hour hand driver, a number of gears are defined on the edge of the hour hand ring and another number of gears are defined on one end of the hour hand driving wheel, which engage with the gears of the hour hand ring, the other end of the hour hand driving wheel is connected to the hour hand driver, the hour hand driver is connected to the controller, the controller controls the hour hand driver to run to drive the hour hand driving wheel to rotate, the rotation of the hour hand driving wheel drives the hour hand ring to rotate; and the minute hand driving unit comprises a minute hand driving wheel and a minute hand driver, a number of gears are defined on the edge of the minute hand ring and another number of gears are defined on one end of the minute hand driving wheel, which engage with the gears of the minute hand ring, the other end of the minute hand driving wheel is connected to the minute hand driver, the minute hand driver is connected to the controller, the controller controls the minute hand driver to run to drive the minute hand driving wheel to rotate, the rotation of the minute hand driving wheel drives the minute hand ring to rotate.

3. The time indication device as described in claim 2, further comprising a second hand module, wherein the second hand module comprises:
a second hand ring is placed around the time display body;
a second hand driver, connected to the controller, is controlled by the controller to drive the second hand ring to rotate around the time display body; and
a second hand projecting unit, fixed to the second hand ring, is for projecting a second hand on the time display body.

4. The time indication device as described in claim 3, wherein the second hand driving unit comprises an second hand driving wheel and an second hand driver, a number of gears are defined on the edge of the second hand ring and another number of gears are defined on one end of the second hand driving wheel, which engage with the gears of the hour hand ring, the other end of the second hand driving wheel is connected to the second hand driver, the second hand driver is connected to the controller, the controller controls the second hand driver to run to drive the second hand driving wheel to rotate, the rotation of the second hand driving wheel drives the second hand ring to rotate.

5. The time indication device as described in claim 4, wherein axial heights of the hour hand ring, the minute hand ring, and the second hand ring are arranged in descending order from outside to inside such that the hour hand projecting unit, the minute hand projecting unit and the second hand projecting unit do not interfere with one another in effectively projecting the hour hand, the minute hand and the second hand, respectively.

6. The time indication device as described in claim 3, wherein the hour hand ring is placed outside the minute hand ring, and the second hand ring is placed inside the minute hand ring.

7. The time indication device as described in claim 3, wherein the hour hand ring is placed inner the minute hand ring, and the second hand ring is placed outside the minute hand ring.

8. The time indication device as described in claim 3, wherein the hour hand projecting unit, the minute hand projecting unit, and the second hand projecting unit are LEDs.

9. The time indication device as described in claim 3, the controller controls the hour hand driver, the minute hand driver, and the second hand driver to rotate in a clockwise direction, and further drives the hour hand ring, the minute hand ring, and the second hand ring to rotate in the clockwise direction, the time calibrations on the time display body are set in the clockwise direction.

10. The time indication device as described in claim 3, the controller controls the hour hand driver, the minute hand driver, and the second hand driver to rotate in a counterclockwise direction, and further drives the hour hand ring, the minute hand ring, and the second hand ring to rotate in the counterclockwise direction, the time calibrations on the time display body are set in counterclockwise direction.

11. The time indication device as described in claim 4, wherein the hour hand driver, the minute hand driver, and the second hand driver are motors.
